(19) United States
(12) Patent Application Publication
(10) Pub. No.: US 2025/0164260 A1
(43) Pub. Date: May 22, 2025

(54) METHOD AND SYSTEM FOR CREATING DRIVE COURSE

(71) Applicant: HYUNDAI AUTOEVER CORP., Seoul (KR)

(72) Inventors: Won Heung JO, Seoul (KR); So Jung KIM, Seoul (KR)

(21) Appl. No.: 18/952,299

(22) Filed: Nov. 19, 2024

(30) Foreign Application Priority Data
Nov. 22, 2023 (KR) 10-2023-0163313

(51) Int. Cl. G01C 21/34

(52) U.S. Cl. CPC G01C 21/3484; G01C 21/3476

(57) ABSTRACT

Methods, devices and systems for creating a drive course are described. According to one embodiment, a method comprises obtaining a first route along which the mobility apparatus has driven, obtaining passenger gaze data while driving along the first route, analyzing the passenger gaze data, determining whether at least a portion of the first route is suitable as a drive course by using analysis results of the passenger gaze data, and transmitting data for the at least the portion of the first route determined to be suitable as the drive course to a navigation service server.

### CROSS-REFERENCE TO RELATED APPLICATION

This application claims priority from Korean Patent Application No. 10-2023-0163313 filed on Nov. 22, 2023 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and system for creating a drive course, and more particularly to a method for registering a road that is determined to be of interest to a passenger while driving as a drive course and a system for performing the method.

### 2. Description of the Related Art

The navigation service aims to obtain a route that meets the criteria of minimum distance or minimum time to the destination from a navigation server and provide the route to a driver of a mobility apparatus.

The recent navigation service obtains a drive course that meets emotional criteria such as a preference for specific POI of the driver of the mobility apparatus and the purpose of driving as well as the minimum distance and minimum time to the destination from the navigation server, and provides the drive course to the driver of the mobility apparatus.

In addition, the navigation service may collect beautiful road data by combining places recommended by passengers who have driven on specific roads or places that have been mentioned positively on SNS, and may create a drive course by using the collected data.

However, a method of collecting road data in a way that recommends roads where the passengers have had a positive driving experience does not guarantee passenger's participation.

Accordingly, a method for collecting road data that is determined to be of interest to the passenger while driving and beautiful road data with good scenery without the passenger having to go through a separate menu, and creating a drive course by using the collected data is required.

### SUMMARY

Aspects of the present disclosure provide a system capable of creating a drive course by collecting road data that is determined to be of interest to a passenger while driving from passenger's motion data without the passenger having to go through a separate menu.

Aspects of the present disclosure also provide a system capable of creating a drive course by collecting beautiful road data with good scenery from place data exposed on SNS.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a method for creating a drive course, performed by a mobility apparatus. The method for creating a drive course method comprises obtaining a first route along which the mobility apparatus has driven, obtaining passenger gaze data while driving along the first route, analyzing the passenger gaze data, determining whether at least a portion of the first route is suitable as a drive course by using the analysis results of the passenger gaze data, and transmitting data for at least a portion of the first route determined to be suitable as the drive course to a navigation service server.

In some embodiments, the obtaining of the passenger gaze data while the driving along the first route may include obtaining condition data of the first route, and obtaining passenger gaze data while driving when the condition data of the first route meets a predefined reference, and the condition data includes one or more of speed data, outdoor scenery data, window data, sound data, and passenger device data.

In some embodiments, the speed data of the mobility apparatus, which is the condition data that meets the predefined reference, may indicate that the mobility apparatus is decelerated while entering the first route.

In some embodiments, the outdoor scenery data, which is the condition data that meets the predefined reference, may indicate that the outdoor scenery data is determined as a predefined landscape.

In some embodiments, the window data, which is the condition data that meets the predefined reference, may indicate that the mobility apparatus opens a window while entering the first route.

In some embodiments, the sound data, which is the condition data that meets the predefined reference, may indicate that decibels of a predefined reference or more occurred inside a mobility while the mobility apparatus enters the first route.

In some embodiments, wherein the passenger device data, which is the condition data that meets the predefined reference, may indicate that photographing is performed on the passenger device linked to the mobility apparatus.

In some embodiments, the determining whether at least a portion of the first route is suitable as the drive course by using the analysis results of the passenger gaze data may include obtaining that a gaze of a passenger on the first route has gazed on the outside for a predefined time or longer; obtaining condition data of the first route, and determining whether at least a portion of the first route is suitable as a drive course when the condition data of the first route meets a predefined reference, and the condition data includes one or more of speed data, outdoor scenery data, window data, sound data, and passenger device data.

In some embodiments, the determining whether at least a portion of the first route is suitable as the drive course may include receiving a drive course report signal from a user.

In some embodiments, the transmitting data for at least a portion of the first route determined to be suitable as the drive course to the navigation service server further may include obtaining search result data by searching the first route on SNS, and registering the first route as the drive course when the search result data satisfy a predefined reference.

In some embodiments, the registering of the first route as the drive course when the search result data satisfy a predefined reference may include registering the first route as the drive course when the search result data satisfy a positive evaluation reference.

In some embodiments, the registering of the first route as the drive course when the search result data satisfy a predefined reference may include registering the first route as the drive course when the search result data satisfy a mention reference.

In some embodiments, the registering of the first route as the drive course when the search result data satisfy a predefined reference may include receiving a hashtag for the first route and mapping the hashtag to the first route.

According to an aspect of the present disclosure, there is a server for creating a drive course, performed by a server. The server comprising a communication interface, a memory into which a computer program is loaded, and one or more processors on which the computer program is executed, wherein the computer program includes an operation of obtaining a first route along which a mobility apparatus has driven, an operation of requesting passenger gaze data while driving along the first route to the mobility apparatus, an operation of obtaining and analyzing the passenger gaze data, an operation of determining whether at least a portion of the first route is suitable as a drive course by using the analysis results of the passenger gaze data, and an operation of registering data for at least a portion of the first route determined to be suitable as the drive course as the drive course.

According to an aspect of the present disclosure, there is a system for creating a drive course, the system comprising one or more processors, and a memory configured to store one or more instructions, wherein the one or more processors execute, by executing the stored one or more instructions, an operation of obtaining a first route along which a mobility apparatus has driven, an operation of obtaining passenger gaze data while driving along the first route, an operation of analyzing the passenger gaze data, an operation of determining whether at least a portion of the first route is suitable as a drive course by using the analysis results of the passenger gaze data, and an operation of transmitting data for at least a portion of the first route determined to be suitable as the drive course to a navigation service server.

In some embodiments, the operation of obtaining the passenger gaze data while driving along the first route may include an operation of obtaining condition data of the first route, and an operation of obtaining passenger gaze data while driving when the condition data of the first route meets a predefined reference, and the condition data includes one or more of speed data, outdoor scenery data, window data, sound data, and passenger device data.

In some embodiments, the window data, which is the condition data that meets the predefined reference, may indicate that the mobility apparatus opens a window while entering the first route.

In some embodiments, the sound data, which is the condition data that meets the predefined reference, may indicate that decibels of a predefined reference or more occurred inside a mobility while the mobility apparatus enters the first route.

In some embodiments, the operation of determining whether at least a portion of the first route is suitable as the drive course by using the analysis results of the passenger gaze data may include an operation of obtaining that a gaze of a passenger on the first route has gazed on the outside for a predefined time or longer, an operation of obtaining condition data of the first route, and an operation of determining whether at least a portion of the first route is suitable as a drive course when the condition data of the first route meets a predefined reference, and the condition data includes one or more of speed data, outdoor scenery data, window data, sound data, and passenger device data.

In some embodiments, the operation of transmitting the data for at least a portion of the first route determined to be suitable as the drive course to the navigation service server further may include an operation of obtaining search result data by searching the first route on SNS, and an operation of registering the first route as the drive course when the search result data satisfy a predefined reference.

### BRIEF DESCRIPTION OF THE DRAWINGS

The above and other aspects and features of the present disclosure will become more apparent by describing in detail exemplary embodiments thereof with reference to the attached drawings, in which:

FIG. 1 is a configuration diagram of a system for creating a drive course according to an exemplary embodiment of the present disclosure;

FIGS. 2 to 5 are flowcharts in which a process of creating a drive course is performed;

FIGS. 6 to 9 are illustrative diagrams for describing a method for obtaining drive course creation conditions;

FIGS. 10 and 11 are illustrative diagrams illustrating navigation screens that provide a drive course creation service; and

FIG. 12 is an illustrative hardware configuration diagram of a system 100 for creating a drive course according to some exemplary embodiments of the present disclosure.

### DETAILED DESCRIPTION OF THE EMBODIMENTS

Hereinafter, preferred embodiments of the present disclosure will be described with reference to the attached drawings. The advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described in detail with reference to the accompanying drawings.

A mobility apparatus according to some exemplary embodiments of the present disclosure may be any one of an automobile, a locomotive, an electric vehicle, a self-driving car, a bicycle, a shared kickboard, and an unmanned aerial vehicle (UAV). In addition, the power used by the mobility apparatus may be an engine, electric power, wind power, tidal power, etc.

Hereinafter, various exemplary embodiments of the present disclosure will be described with reference to the accompanying drawings.

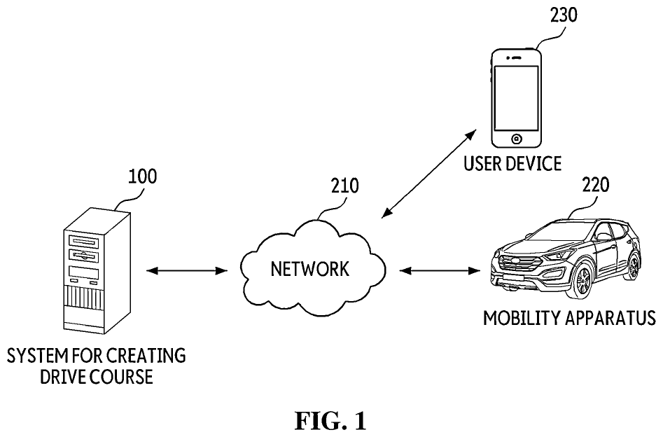

FIG. 1 is a configuration diagram of a system for creating a drive course according to an exemplary embodiment of the present disclosure. As illustrated in FIG. 1, the system 100 for creating the drive course may be connected to a mobility apparatus 220 through a network 210 to obtain condition data for creating a drive course from the mobility apparatus 220, may select a road suitable for the obtained condition data, and may create the selected road as the drive course.

The system 100 for creating the drive course may be connected to a user device 230 through the network 210 to obtain background data for determining a route from the user device 230, may determine a route suitable for the obtained background data, and may provide the determined route to the user device 230.

The user device 230 may be a mobile terminal such as a navigation device built into a mobility apparatus 220 or a smartphone with a navigation app installed. The user device 230 linked to the mobility apparatus 220 may perform an operation of obtaining some of the condition data for creating the drive course.

The mobility apparatus 220 and the user device 230 linked to the mobility apparatus 220 may be devices that obtain a driving status of the mobility apparatus 220 and internal/external environmental data of the mobility apparatus 220. The driving status of the mobility apparatus 220 and the internal/external environmental data of the mobility apparatus 220 may be background data for determining the route. In this case, the mobility apparatus 220 may include sensors mounted inside and outside the mobility apparatus.

The mobility apparatus 220 may obtain speed data of the mobility apparatus 220 as condition data for creating the drive course. The speed data of the mobility apparatus 220 obtained through the mobility apparatus 220 may include the speed of the mobility apparatus 220, the time at which the speed suddenly increased or decreased, and the location at which the mobility apparatus 220 was located at that time.

The speed data of the mobility apparatus 220 may be used as the condition data for creating the drive course. For example, the speed of the mobility apparatus that has suddenly decreased, the time at which the speed of the mobility apparatus 220 has suddenly decreased, and the location at which the mobility apparatus 220 was located at the time at which the speed of the mobility apparatus has suddenly decreased among the speed data of the mobility apparatus 220 obtained through the mobility apparatus 220 may be used as feature points indicating that a passenger discovered a beautiful outdoor scenery, the time the passenger slows down the driving speed and enjoys an outdoor scenery, and the location where the mobility apparatus 220 was located at that time.

The speed of the mobility apparatus that has suddenly increased, the time at which the speed of the mobility apparatus 220 has suddenly increased, and the location at which the mobility apparatus 220 was located at the time at which the speed of the mobility apparatus has suddenly increased among the speed data of the mobility apparatus 220 obtained through the mobility apparatus 220 may be used as feature points indicating that the beautiful outdoor scenery that the passenger was enjoying was cut off, the time at which the passenger resumes the driving speed, finishes the enjoying, and starts driving again, and the location where the mobility apparatus 220 was located at that time.

The mobility apparatus 220 may obtain window data of the mobility apparatus 220 as condition data for creating the drive course. The window data obtained through the mobility apparatus 220 may include a signal generated to manipulate a window of the mobility apparatus 220, the time at which the window is manipulated, and the location where the mobility apparatus 220 was located at that time.

The window data of the mobility apparatus 220 may be used as the condition data for creating the drive course. For example, the signal for opening the window, the time at which the window was opened, and the location where the mobility apparatus 220 was located at that time, obtained through the mobility apparatus 220 may be used feature points indicating hat a passenger discovered a beautiful outdoor scenery, the time at which the passenger opened the windows and enjoyed the outside, and the location where the mobility apparatus 220 was located at that time.

A signal for closing the window, the time at which the window was closed, and the location where the mobility apparatus 220 was located at that time, obtained through the mobility apparatus 220 may be used feature points indicating hat the beautiful outdoor scenery that the passenger had been enjoying ended, the time at which the passenger closed the windows and finished enjoying the outside, and the location where the mobility apparatus 220 was located at that time.

The mobility apparatus 220 may obtain passenger device data as condition data for creating the drive course. The passenger device may be the same device as the user device 230. The passenger device data may include signals generated to manipulate the passenger device linked to the mobility apparatus 220 via wireless communication including NFC, Bluetooth, Zigbee, or a beacon. The passenger device data may include a signal at which the photographing is performed using the passenger device, the time at which the signal was generated, and the location where the mobility apparatus 220 was located at that time.

The passenger device data may be used as the condition data for creating the drive course. For example, the signal at which the photographing is performed using the passenger device, the time at which the signal was generated, and the location where the mobility apparatus 220 was located at that time may be used as feature points indicating that the passenger discovers beautiful outdoor scenery and takes picture of the outside, the time at which the passenger took picture of the outside, and the location where the mobility apparatus 220 was located at that time.

The mobility apparatus 220 including a sensor mounted inside the mobility apparatus 220 may obtain passenger gaze data obtained by tracking a gaze of the passenger riding inside the mobility apparatus 220, as condition data for creating the drive course. The passenger gaze data may include a signal generated when the passenger's gaze gazes on the outside for a predefined time or longer, the time at which the signal was generated, and the location where the mobility apparatus 220 was located at that time.

The passenger gaze data may be used as the condition data for creating the drive course. For example, the signal generated when the passenger's gaze gazes on the outside for a predefined time or longer, the time at which the signal was generated, and the location where the mobility apparatus 220 was located at that time, obtained through the mobility apparatus 220 may be used feature points indicating hat a passenger discovered a beautiful outdoor scenery and gazed on the outside, the time at which the passenger enjoyed the outside, and the location where the mobility apparatus 220 was located at that time.

The mobility apparatus 220 including a sensor mounted inside the mobility apparatus 220 may obtain sound data generated inside the mobility apparatus 220 as condition data for creating the drive course. The sound data may include a signal generated when decibels of a predefined standard or more are generated within the mobility, the time at which the signal was generated, and the location where the mobility apparatus 220 was located at that time.

The sound data may be used as the condition data for creating the drive course. For example, the signal generated when decibels of a predefined standard or more are measured within the mobility, the time at which the signal was generated, and the location where the mobility apparatus 220 was located at that time, obtained through the sensor mounted inside the mobility apparatus 220 may be used feature points indicating that the passenger enjoys the outside and expresses emotion through sound, the time at which the passenger discovered an outside beautiful road, and the location where the mobility apparatus was operating at that time.

The mobility apparatus 220 including a sensor mounted outside the mobility apparatus 220 may obtain outdoor scenery data of the mobility apparatus as condition data for creating the drive course. The outdoor scenery data may include an image obtained by photographing the outside of the mobility, predefined landscape images, and whether the image obtained by photographing the outside of the mobility is determined to fall into any of the categories of the predefined landscape images.

The outdoor scenery data may be used as the condition data for creating the drive course. For example, when it is determined that the mobility outside image obtained through the sensor mounted outside the mobility apparatus 220 is included in the sea, which is a predefined landscape category, the location where the image was obtained may be used as a feature point indicating that it is the location included in the sea, which is one of the predefined landscape categories.

The system 100 for creating the drive course may receive, from the user device 230, background data for determining a route including a destination, a current location, and a separate starting location other than the current location. The user device 230 may receive route data for reaching the destination and map data on which the route is mapped from the system 100 for creating the drive course.

The system 100 for creating the drive course determines a route suitable for the obtained background data and transmits the route to the user device 230, and may transmit the most efficient route. For example, the system 100 for creating the drive course may determine a route that takes the shortest time, consumes the least cost, or allows the shortest distance to be traveled, and transmit the determined route to the user device.

The system 100 for creating the drive course may create a drive course that includes not only an efficient route but also a beautiful road among the routes to reach the destination from the user device 230 and transmit the created drive course to the user device.

In addition, the user device 230 may store the route data for reaching the destination and the map data on which the route is mapped, received from the system 100 for creating the drive course, in a local storage provided within the user device 230.

According to some exemplary embodiments of the present disclosure, the user device 230 that obtains the drive course data created by the system 100 for creating the drive course may provide a comfortable and enjoyable driving experience to the user.

However, these are only examples, and each example will be described in more detail through the drawings below.

A processing system according to the present exemplary embodiment may include the system 100 for creating the drive course. The system 100 for creating the drive course may be configured as one or more computing devices. For example, the system 100 for creating the drive course may be configured as one or more cloud compute instances. That is, the system 100 for creating the drive course may be configured as at least some compute instances of one or more virtual machines and one or more containers. In addition, the system 100 for creating the drive course may also be configured to include both an on-premise physical server and the cloud compute instance. For example, considering situations where texts with high security requirements need to be processed, a module that analyzes input text or at least temporarily stores the input text may be implemented on the on-premise physical server located in an internal network blocked from the Internet by a firewall, and other modules may be configured using the cloud compute instances.

Hereinabove, the configuration and operation of the processing system according to the exemplary embodiment of the present disclosure have been described with reference to FIG. 1. An operation method of the system 100 for creating the drive course of the processing system of the present disclosure may be understood in more detail with reference to other exemplary embodiments to be described later. In addition, the technical ideas that may be understood through the above-described exemplary embodiments of the processing system according to the present exemplary embodiment may be applied to other exemplary embodiments to be described later even if not specifically stated.

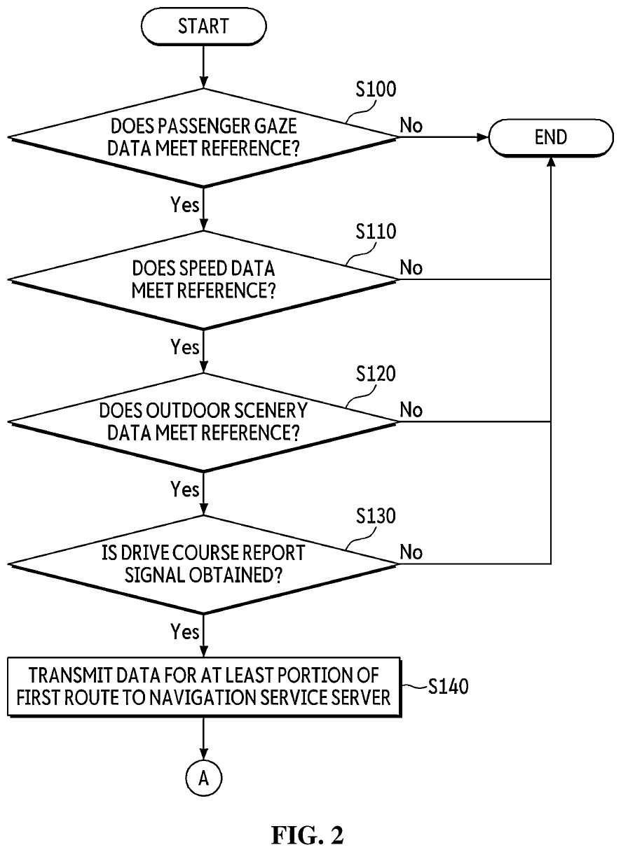

A method for creating a drive course according to another exemplary embodiment of the present disclosure will be described with reference to FIG. 2. FIGS. 2 to 5 are flowcharts for describing an implementation process of creating a drive course. The method for creating the drive course according to the present exemplary embodiment may be performed by one or more computing systems.

In addition, in the method for creating the drive course according to the present exemplary embodiment, some operations may be performed by a first computing device, and the remaining operations may be performed by a second computing device. For example, some operations of the method for creating the drive course according to the present exemplary embodiment may be performed by an on-premise physical server, and the remaining operations may be performed by cloud compute instances. Hereinafter, if the subject performing each operation is omitted, it may be understood that the performing subject is the computing system.

First, in step S100, a sensor mounted inside a mobility apparatus may obtain passenger gaze data as condition data for creating a drive course by tracking a gaze of a passenger riding inside the mobility apparatus. The system for creating the drive course that receives the passenger gaze data as the condition data for creating the drive course may determine whether the passenger gaze data satisfy a reference.

If a passenger gaze included in the obtained passenger gaze data gazes on the outside for a predefined time or longer, the system for creating the drive course may determine that the passenger gaze data satisfy the reference. If the passenger gaze data satisfy the reference, the system for creating the drive course may create a passenger gaze data reference matching signal.

The system for creating the drive course may use the passenger gaze data reference matching signal as a trigger for receiving other condition data for creating the drive course. Therefore, when the passenger gaze data reference matching signal occurs, the system for creating the drive course may receive other condition data.

If the passenger gaze included in the obtained passenger gaze data does not gaze on the outside for a predefined time or longer, the system for creating the drive course may determine that the passenger gaze data does not meet the reference. If the passenger gaze data does not meet the reference, the system for creating the drive course may terminate the process of creating the drive course.

Specifically, a passenger gaze tracking sensor mounted inside the mobility apparatus may obtain a signal generated when the passenger's gaze gazes on the outside for a predefined time or longer, the time at which the signal was generated, and the location where the mobility apparatus was located at that time. The signal generated when the passenger's gaze gazes on the outside for a predefined time or longer, the time at which the signal was generated, and the location where the mobility apparatus was located at that time may be used feature points indicating hat the passenger discovered a beautiful outdoor scenery and gazed on the outside, the time at which the passenger enjoyed the outside, and the location where the mobility apparatus 220 was located at that time.

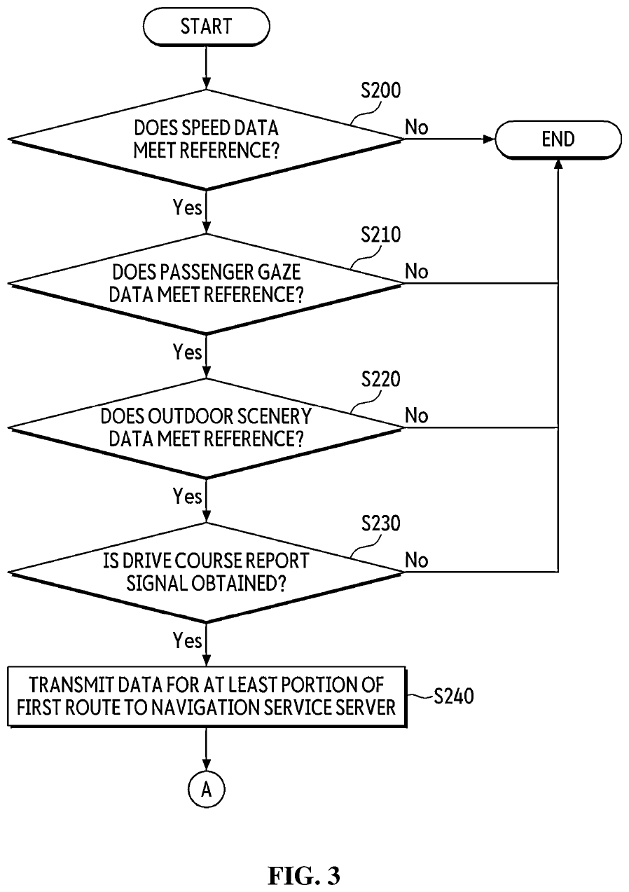

The sensors mounted inside the mobility apparatus may track a gaze of the passenger riding inside the mobility apparatus every hour. The sensors mounted inside the mobility apparatus may track the gaze of the passenger riding inside the mobility apparatus at predefined intervals. The sensors mounted inside the mobility apparatus may track the gaze of the passenger riding inside the mobility apparatus when certain condition data satisfy the reference. The sensor mounted inside the mobility apparatus that performs the tracking when the certain condition data satisfy the reference will be described later with reference to FIG. 3.

The passenger gaze tracking sensor mounted inside the mobility apparatus may track the gaze of not only a driver but also the front passenger and rear passengers. The system for creating the drive course may determine that the passenger gaze data satisfy the reference, when the number of people who have gazed on the outside for a predefined time or longer obtained by the passenger gaze tracking sensor is one or more. The system for creating the drive course may determine that the passenger gaze data satisfy the reference, when the number of people who have gazed on the outside for a predefined time or longer obtained by the passenger gaze tracking sensor is half or more. The system for creating the drive course may determine that the passenger gaze data satisfy the reference, when a person sitting on a predefined seat gazes on the outside for a predefined time or longer, regardless of the number of people who have gazed on the outside for a predefined time or longer obtained by the passenger gaze tracking sensor.

If the passenger gaze included in the obtained passenger gaze data gazes on the outside for a predefined time or longer and is terminated, the system for creating the drive course may determine that the passenger gaze data satisfy a second reference. If the passenger gaze data satisfy the second reference, the system for creating the drive course may create a passenger gaze data second reference matching signal.

When the passenger gaze data satisfy the second reference, the system for creating the drive course may use the termination of the outside gaze of the passenger, the time at which the outside gaze of the passenger is terminated, and the location where the mobility apparatus was located at that time, as feature points indicting that the beautiful outdoor scenery that the passenger was enjoying was cut off, the time at which the passenger finishes the enjoying and starts driving, and the location where the mobility apparatus was located at that time.

The system for creating the drive course may include a location included in the gaze data that meets the second reference in data of a first route.

The system for creating the drive course that receives the passenger gaze data as the condition data for creating the drive course may derive an effect of creating the drive course by collecting road data that is determined to be of interest to the passenger while driving from passenger's motion data without the passenger having to go through a separate menu.

Next, in step S110, the mobility apparatus may obtain speed data of the mobility apparatus as condition data for creating the drive course. The system for creating the drive course that receives the speed data of the mobility apparatus as the condition data for creating the drive course may determine whether the speed data satisfy a reference.

If a decreased speed included in the obtained speed data is decreased by a value of a predefined reference or more, the system for creating the drive course may determine that the speed data satisfy the reference. If the speed data satisfy the reference, the system for creating the drive course may create a speed data reference matching signal.

The system for creating the drive course may use the speed data reference matching signal as a trigger for receiving other condition data for creating the drive course. Therefore, when the speed data reference matching signal occurs, the system for creating the drive course may receive other condition data.

If the decreased speed included in the obtained speed data is not decreased by a value of a predefined reference or more, the system for creating the drive course may determine that the speed data does not meet the reference. If the speed data does not meet the reference, the system for creating the drive course may terminate the process of creating the drive course.

Specifically, the mobility apparatus may obtain a speed that is suddenly decelerated, the time at which the deceleration occurred, and the location where the mobility apparatus was located at that time. The speed that is abruptly decelerated, the time at which the deceleration occurred, and the location where the mobility apparatus was located at that time may be used as feature points indicating that the passenger is discovering beautiful outdoor scenery, slowing down a driving speed, and driving while enjoying the outdoor scenery, the time at which the passenger enjoyed the outside, and the location where the mobility apparatus was located at that time.

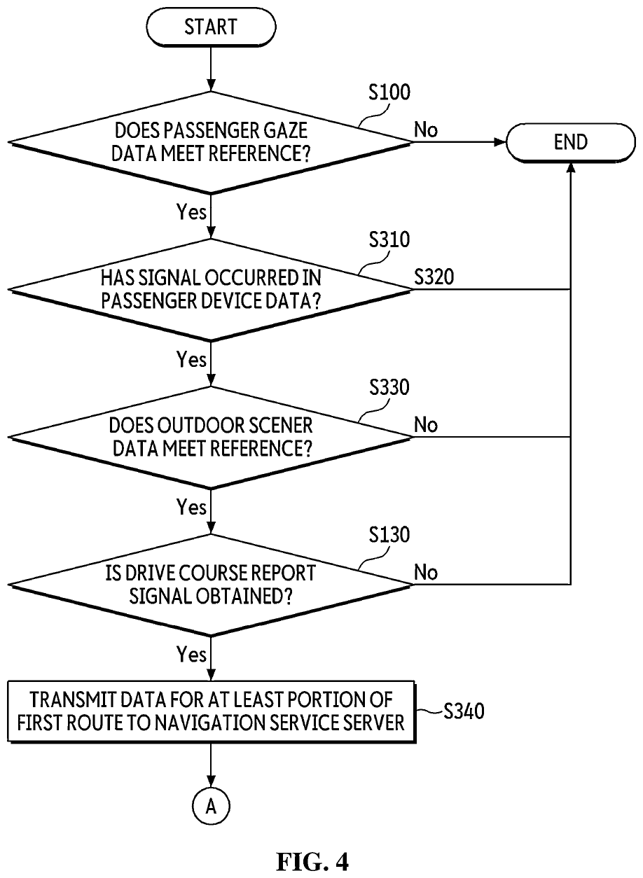

When the passenger gaze data reference matching signal occurs, the mobility apparatus may check the speed of the mobility apparatus and transmit the checked speed to the system for creating the drive course. The mobility apparatus may check the speed of the mobility apparatus every hour and transmit the checked speed to the system for creating the drive course. The mobility apparatus may check the speed of the mobility apparatus at predefined intervals and transmit the checked speed to the system for creating the drive course. When certain condition data satisfy the reference, the mobility apparatus may transmit the speed of the mobility apparatus to the system for creating the drive course. The mobility apparatus that transmits the speed of the mobility apparatus to the system for creating the drive course when the certain condition data satisfy the reference will be described later with reference to FIG. 4.

If an increased speed included in the obtained speed data is increased by a value of a predefined reference or more, the system for creating the drive course may determine that the speed data satisfy the second reference. If the speed data satisfy the second reference, the system for creating the drive course may create a speed data second reference matching signal.

If the speed data satisfy the second reference, the system for creating the drive course may use the speed of the mobility apparatus that has suddenly increased, the time at which the speed of the mobility apparatus has suddenly increased, and the location at which the mobility apparatus was located at the time at which the speed of the mobility apparatus has suddenly increased, as feature points indicating that the beautiful outdoor scenery that the passenger had been enjoying was cut off, the time at which the passenger resumes the driving speed, finishes the enjoying, and starts driving again, and the location where the mobility apparatus was located at that time.

Next, in step S120, the mobility apparatus may obtain outdoor scenery data of the mobility apparatus, which is an image obtained by photographing the outside of the mobility apparatus, as condition data for creating the drive course. The system for creating the drive course that receives the outdoor scenery data of the mobility apparatus as the condition data for creating the drive course may determine whether the outdoor scenery data satisfy a reference.

If a mobility outside image obtained through a sensor mounted outside the mobility apparatus included in the acquired outdoor scenery data is included in a predefined landscape category, the system for creating the drive course may determine that the outdoor scenery data satisfy the reference. If the outdoor scenery data satisfy the reference, the system for creating the drive course may create an outdoor scenery data reference matching signal.

The system for creating the drive course may use the outdoor scenery data reference matching signal as a trigger for receiving other condition data for creating the drive course. Therefore, when the outdoor scenery data reference matching signal occurs, the system for creating the drive course may receive other condition data.

The system for creating the drive course may use the outdoor scenery data reference matching signal as a trigger for obtaining a drive course report signal of a user for creating the drive course (S130). Therefore, when the outdoor scenery data reference matching signal occurs, the system for creating the drive course may obtain the drive course report signal.

If the mobility outside image included in the obtained outdoor scenery data is not included in a predefined landscape category, the system for creating the drive course may determine that the outdoor scenery data does not meet the reference. If the outdoor scenery data does not meet the reference, the system for creating the drive course may terminate the process of creating the drive course.

For example, when it is determined that the mobility outside image obtained through the sensor mounted outside the mobility apparatus is included in the sea, which is a predefined landscape category, the location where the image was obtained may be used as a feature point indicating that it is the location included in the sea, which is one of the predefined landscape categories.

When the passenger gaze data reference matching signal occurs, the mobility apparatus may obtain an outside image of the mobility apparatus and transmit the obtained outside image to the system for creating the drive course. The mobility apparatus may obtain the outside image of the mobility apparatus every hour and transmit the obtained outside image to the system for creating the drive course. The mobility apparatus may check the outside image of the mobility apparatus at predefined intervals and transmit the checked outside image to the system for creating the drive course. When certain condition data satisfy the reference, the mobility apparatus may transmit the outside image of the mobility apparatus to the system for creating the drive course. The mobility apparatus that transmits the outside image of the mobility apparatus to the system for creating the drive course when the certain condition data satisfy the reference will be described later with reference to FIG. 4.

Next, in step S130, the system for creating the drive course may obtain a drive course report signal. The system for creating the drive course may confirm that a section in which the condition data obtained from at least some sections of the first route driven immediately before is determined to meet the reference is a road in which the passenger actually takes an interest in while driving, by receiving the drive course report signal from the passenger.

The system for creating the drive course may obtain the drive course report signal by providing a drive course report screen to a user device or a passenger device and receiving a report selection input from the user.

The system for creating the drive course may terminate the process of creating the drive course by providing the drive course report screen to the user device or the passenger device and receiving a report non-selection input from the user. The system for creating the drive course may confirm that the section in which the condition data obtained from at least some sections of the first route driven immediately before is determined to meet the reference is not a road in which the passenger actually takes an interest in while driving and is a motion that occurred as a separate event other than the outdoor scenery, by receiving a drive course non-report signal from the passenger.

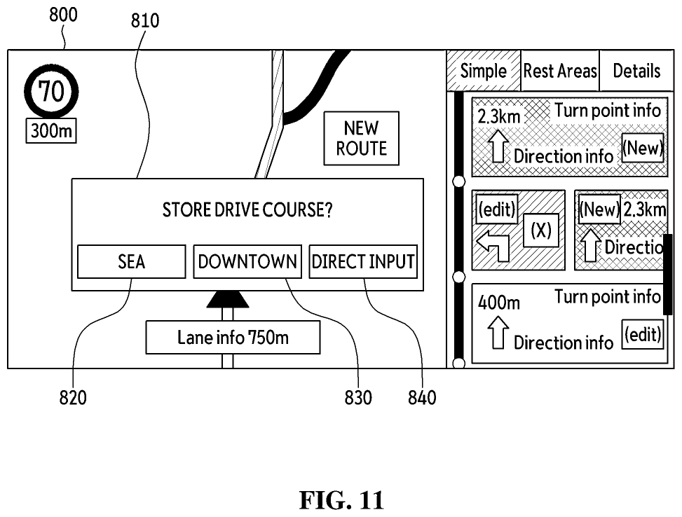

When certain condition data satisfy the reference, the user device mounted on the mobility apparatus or the passenger device riding in the mobility apparatus may provide a drive course report screen, receive a report selection or report non-selection from the user through the screen, and transmit the received selection of the user to the system for creating the drive course. The screen of the user device or passenger device that creates the report selection screen and provides it to the user, and receives the report selection or non-selection from the user will be described later with reference to FIG. 11.

Next, in step S140, the system for creating the drive course may transmit data for a road included in a first route that has certain condition data that meets the reference and is selected by the user for reporting to the navigation service server.

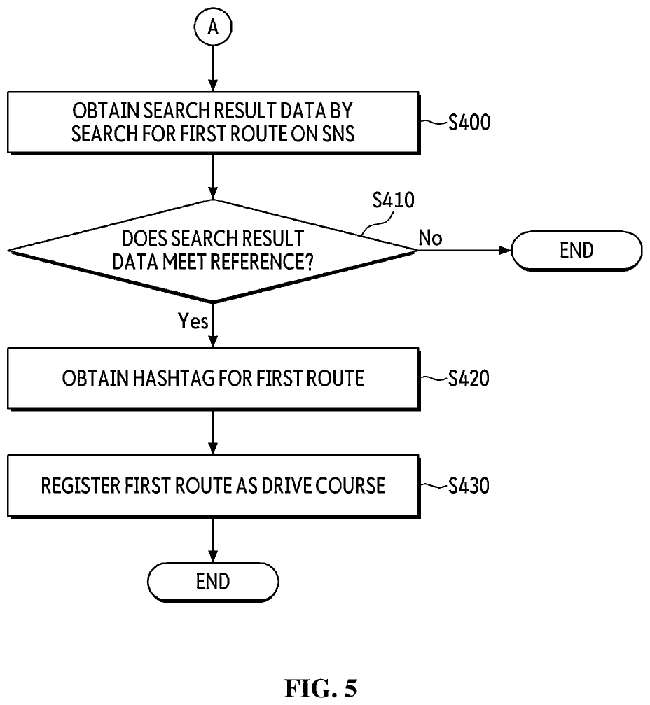

Some roads of the first route transmitted to the navigation service server may be designated as drive course candidates A. The step of creating the road designated as the drive course candidate A as the drive course will be described later with reference to FIG. 5. The system for creating the drive course that has obtained the second reference matching signal may also transmit data included in the second reference matching signal to the service server.

Next, another exemplary embodiment of designating some roads of the first route as drive course candidates A will be described with reference to FIG. 3.

First, in step S200, the mobility apparatus may obtain speed data of the mobility apparatus as condition data for creating a drive course. The system for creating the drive course that receives the speed data of the mobility apparatus as the condition data for creating the drive course may determine whether the speed data satisfy a reference.

If a decreased speed included in the obtained speed data is decreased by a value of a predefined reference or more, the system for creating the drive course may determine that the speed data satisfy the reference. If the speed data satisfy the reference, the system for creating the drive course may create a speed data reference matching signal.

The system for creating the drive course may use the speed data reference matching signal as a trigger for receiving other condition data for creating the drive course. Therefore, when the speed data reference matching signal occurs, the system for creating the drive course may receive other condition data.

If the decreased speed included in the obtained speed data is not decreased by a value of a predefined reference or more, the system for creating the drive course may determine that the speed data does not meet the reference. If the speed data does not meet the reference, the system for creating the drive course may terminate the process of creating the drive course.

The system for creating the drive course that receives the speed data as the condition data for creating the drive course may derive an effect of creating the drive course by collecting road data that is determined to be of interest to the passenger while driving from passenger's motion data without the passenger having to go through a separate menu.

In addition, since the system for creating the drive course that creates the drive course by using the speed data as the most important condition data for creating the drive course always uses the speed data that is being checked, it is possible to derive an effect of creating the drive course without going through a separate process of transmitting/receiving and calculating excessive data.

Next, in step S210, a sensor mounted inside a mobility apparatus may obtain passenger gaze data as condition data for creating a drive course by tracking a gaze of a passenger riding inside the mobility apparatus. The system for creating the drive course that receives the passenger gaze data as the condition data for creating the drive course may determine whether the passenger gaze data satisfy a reference.

If a passenger gaze included in the obtained passenger gaze data gazes on the outside for a predefined time or longer, the system for creating the drive course may determine that the passenger gaze data satisfy the reference. If the passenger gaze data satisfy the reference, the system for creating the drive course may create a passenger gaze data reference matching signal.

The system for creating the drive course may use the passenger gaze data reference matching signal as a trigger for receiving other condition data for creating the drive course. Therefore, when the passenger gaze data reference matching signal occurs, the system for creating the drive course may receive other condition data.

If the passenger gaze included in the obtained passenger gaze data does not gaze on the outside for a predefined time or longer, the system for creating the drive course may determine that the passenger gaze data does not meet the reference. If the passenger gaze data does not meet the reference, the system for creating the drive course may terminate the process of creating the drive course.

Next, in step S220, the mobility apparatus may obtain outdoor scenery data of the mobility apparatus, which is an image obtained by photographing the outside of the mobility apparatus, as condition data for creating the drive course. The system for creating the drive course that receives the outdoor scenery data of the mobility apparatus as the condition data for creating the drive course may determine whether the outdoor scenery data satisfy a reference.

If a mobility outside image obtained through a sensor mounted outside the mobility apparatus included in the acquired outdoor scenery data is included in a predefined landscape category, the system for creating the drive course may determine that the outdoor scenery data satisfy the reference. If the outdoor scenery data satisfy the reference, the system for creating the drive course may create an outdoor scenery data reference matching signal.

The system for creating the drive course may use the outdoor scenery data reference matching signal as a trigger for receiving other condition data for creating the drive course. Therefore, when the outdoor scenery data reference matching signal occurs, the system for creating the drive course may receive other condition data.

The system for creating the drive course may use the outdoor scenery data reference matching signal as a trigger for obtaining a drive course report signal of a user for creating the drive course (S240). Therefore, when the outdoor scenery data reference matching signal occurs, the system for creating the drive course may obtain the drive course report signal.

If the mobility outside image included in the obtained outdoor scenery data is not included in a predefined landscape category, the system for creating the drive course may determine that the outdoor scenery data does not meet the reference. If the outdoor scenery data does not meet the reference, the system for creating the drive course may terminate the process of creating the drive course.

When the passenger gaze data reference matching signal occurs, the mobility apparatus may obtain an outside image of the mobility apparatus and transmit the obtained outside image to the system for creating the drive course. The mobility apparatus may obtain the outside image of the mobility apparatus every hour and transmit the obtained outside image to the system for creating the drive course. The mobility apparatus may check the outside image of the mobility apparatus at predefined intervals and transmit the checked outside image to the system for creating the drive course. When certain condition data satisfy the reference, the mobility apparatus may transmit the outside image of the mobility apparatus to the system for creating the drive course.

Next, in step S230, the system for creating the drive course may obtain a drive course report signal. The system for creating the drive course may confirm that a section in which the condition data obtained from at least some sections of the first route driven immediately before is determined to meet the reference is a road in which the passenger actually takes an interest in while driving, by receiving the drive course report signal from the passenger.

The system for creating the drive course may obtain the drive course report signal by providing a drive course report screen to a user device or a passenger device and receiving a report selection input from the user.

The system for creating the drive course may terminate the process of creating the drive course by providing the drive course report screen to the user device or the passenger device and receiving a report non-selection input from the user. The system for creating the drive course may confirm that the section in which the condition data obtained from at least some sections of the first route driven immediately before is determined to meet the reference is not a road in which the passenger actually takes an interest in while driving and is a motion that occurred as a separate event other than the outdoor scenery, by receiving a drive course non-report signal from the passenger.

When certain condition data satisfy the reference, the user device mounted on the mobility apparatus or the passenger device riding in the mobility apparatus may provide a drive course report screen, receive a report selection or report non-selection from the user through the screen, and transmit the received selection of the user to the system for creating the drive course. The screen of the user device or passenger device that creates the report selection screen and provides it to the user, and receives the report selection or non-selection from the user will be described later with reference to FIG. 11.

Next, in step S240, the system for creating the drive course may transmit data for a road included in a first route that has certain condition data that meets the reference and is selected by the user for reporting to the navigation service server.

Some roads of the first route transmitted to the navigation service server may be designated as drive course candidates A. The step of creating the road designated as the drive course candidate A as the drive course will be described later with reference to FIG. 5.

Next, still another exemplary embodiment of designating some roads of the first route as drive course candidates A will be described with reference to FIG. 4.

First, in step S100, a sensor mounted inside a mobility apparatus may obtain passenger gaze data as condition data for creating a drive course by tracking a gaze of a passenger riding inside the mobility apparatus. The system for creating the drive course that receives the passenger gaze data as the condition data for creating the drive course may determine whether the passenger gaze data satisfy a reference.

If a passenger gaze included in the obtained passenger gaze data gazes on the outside for a predefined time or longer, the system for creating the drive course may determine that the passenger gaze data satisfy the reference. If the passenger gaze data satisfy the reference, the system for creating the drive course may create a passenger gaze data reference matching signal.

The system for creating the drive course may use the passenger gaze data reference matching signal as a trigger for receiving other condition data for creating the drive course. Therefore, when the passenger gaze data reference matching signal occurs, the system for creating the drive course may receive other condition data.

Next, in step S310, the mobility apparatus may obtain passenger device data as condition data for creating the drive course. The system for creating the drive course that receives the speed data of the mobility apparatus as the condition data for creating the drive course may determine whether the passenger device data satisfy a reference.

When a signal to perform photographing using the passenger device included in the obtained passenger device data is generated, the system for creating the drive course may determine that the passenger device data satisfy the reference. If the passenger device data satisfy the reference, the system for creating the drive course may create a passenger device data reference matching signal.

The system for creating the drive course may use the passenger device data reference matching signal as a trigger for receiving other condition data for creating the drive course. Therefore, when the passenger device data reference matching signal occurs, the system for creating the drive course may receive other condition data.

When the photographing is not performed using the passenger device included in the obtained passenger device data, the system for creating the drive course may determine that the passenger device data does not meet the reference. If the passenger device data does not meet the reference, the system for creating the drive course may terminate the process of creating the drive course.

Specifically, the mobility apparatus may obtain a signal at which the photographing is performed using the passenger device, the time at which the signal was generated, and the location where the mobility apparatus was located at that time. The signal at which the photographing is performed, the time at which the signal was generated, and the location where the mobility apparatus was located at that time may be used as feature points indicating that the passenger is discovering beautiful outdoor scenery, is enjoying the outdoor scenery, and takes a photo using the passenger device, the time at which the passenger enjoyed the outside, and the location where the mobility apparatus was located at that time.

Next, in step S320, the mobility apparatus may obtain outdoor scenery data of the mobility apparatus, which is an image obtained by photographing the outside of the mobility apparatus, as condition data for creating the drive course. The system for creating the drive course that receives the outdoor scenery data of the mobility apparatus as the condition data for creating the drive course may determine whether the outdoor scenery data satisfy a reference.

If a mobility outside image obtained through a sensor mounted outside the mobility apparatus included in the acquired outdoor scenery data is included in a predefined landscape category, the system for creating the drive course may determine that the outdoor scenery data satisfy the reference. If the outdoor scenery data satisfy the reference, the system for creating the drive course may create an outdoor scenery data reference matching signal.

The system for creating the drive course may use the outdoor scenery data reference matching signal as a trigger for receiving other condition data for creating the drive course. Therefore, when the outdoor scenery data reference matching signal occurs, the system for creating the drive course may receive other condition data.

The system for creating the drive course may use the outdoor scenery data reference matching signal as a trigger for obtaining a drive course report signal of a user for creating the drive course (S340). Therefore, when the outdoor scenery data reference matching signal occurs, the system for creating the drive course may obtain the drive course report signal.

If the mobility outside image included in the obtained outdoor scenery data is not included in a predefined landscape category, the system for creating the drive course may determine that the outdoor scenery data does not meet the reference. If the outdoor scenery data does not meet the reference, the system for creating the drive course may terminate the process of creating the drive course.

When the passenger gaze data reference matching signal occurs, the mobility apparatus may obtain an outside image of the mobility apparatus and transmit the obtained outside image to the system for creating the drive course. The mobility apparatus may obtain the outside image of the mobility apparatus every hour and transmit the obtained outside image to the system for creating the drive course. The mobility apparatus may check the outside image of the mobility apparatus at predefined intervals and transmit the checked outside image to the system for creating the drive course. When certain condition data satisfy the reference, the mobility apparatus may transmit the outside image of the mobility apparatus to the system for creating the drive course.

Next, in step S330, the system for creating the drive course may obtain a drive course report signal. The system for creating the drive course may confirm that a section in which the condition data obtained from at least some sections of the first route driven immediately before is determined to meet the reference is a road in which the passenger actually takes an interest in while driving, by receiving the drive course report signal from the passenger.

The system for creating the drive course may obtain the drive course report signal by providing a drive course report screen to a user device or a passenger device and receiving a report selection input from the user.

The system for creating the drive course may terminate the process of creating the drive course by providing the drive course report screen to the user device or the passenger device and receiving a report non-selection input from the user. The system for creating the drive course may confirm that the section in which the condition data obtained from at least some sections of the first route driven immediately before is determined to meet the reference is not a road in which the passenger actually takes an interest in while driving and is a motion that occurred as a separate event other than the outdoor scenery, by receiving a drive course non-report signal from the passenger.

When certain condition data satisfy the reference, the user device mounted on the mobility apparatus or the passenger device riding in the mobility apparatus may provide a drive course report screen, receive a report selection or report non-selection from the user through the screen, and transmit the received selection of the user to the system for creating the drive course. The screen of the user device or passenger device that creates the report selection screen and provides it to the user, and receives the report selection or non-selection from the user will be described later with reference to FIG. 11.

Next, in step S340, the system for creating the drive course may transmit data for a road included in a first route that has certain condition data that meets the reference and is selected by the user for reporting to the navigation service server.

Some roads of the first route transmitted to the navigation service server may be designated as drive course candidates A. The step of creating the road designated as the drive course candidate A as the drive course will be described later with reference to FIG. 5.

As described with reference to FIGS. 2 to 4, the order of obtaining data to be obtained as the condition data for creating the drive course, and the data may change depending on driver and passenger preferences or the driving situation.

Examples of the data that the system for creating the drive course may obtain as the condition data for creating the drive course may include window data and sound data in addition to the passenger gaze data, the speed data, the outdoor scenery data, and the passenger device data described above.

The mobility apparatus may obtain window data, which is a signal generated to manipulate a window of the mobility apparatus, as condition data for creating a drive course. The system for creating the drive course that receives the window data, which is the signal generated to manipulate the window of the mobility apparatus, as the condition data for creating the drive course may determine whether the window data satisfy a reference.

If there is a signal that opened the window in the obtained window data, the system for creating the drive course may create a window data reference matching signal.

The system for creating the drive course may use the window data reference matching signal as a trigger for receiving other condition data for creating the drive course. Therefore, when the window data reference matching signal occurs, the system for creating the drive course may receive other condition data.

The system for creating the drive course may use the window data reference matching signal as a trigger for obtaining a drive course report signal of a user for creating the drive course. Therefore, when the window data reference matching signal occurs, the system for creating the drive course may obtain the drive course report signal.

If there is no signal that opened the window in the obtained window data, the system for creating the drive course may determine that the window data does not meet the reference. If the window data does not meet the reference, the system for creating the drive course may terminate the process of creating the drive course.

The mobility apparatus may obtain sound data generated inside the mobility apparatus as condition data for creating a drive course through a sensor mounted inside the mobility apparatus. The system for creating the drive course that receives the sound data of the mobility apparatus as the condition data for creating the drive course may determine whether the sound data satisfy a reference.

If decibels of a predefined reference or more are measured in the obtained sound data, the system for creating the drive course may generate a sound data reference matching signal.

The system for creating the drive course may use the sound data reference matching signal as a trigger for receiving other condition data for creating the drive course. Therefore, when the sound data reference matching signal occurs, the system for creating the drive course may receive other condition data.

The system for creating the drive course may use the sound data reference matching signal as a trigger for obtaining a drive course report signal of a user for creating the drive course. Therefore, when the sound data reference matching signal occurs, the system for creating the drive course may obtain the drive course report signal.

If there is no signal in which the decibels of the predefined reference or more are measured in the obtained sound data, the system for creating the drive course may determine that the sound data does not meet the reference. If the sound data does not meet the reference, the system for creating the drive course may terminate the process of creating the drive course.

Next, the step of creating the road designated as the drive course candidate A as the drive course will be described with reference to FIG. 5.

First, in step S400, the system for creating the drive course may search for a first route including a road designated as a drive course candidate A on SNS. The system for creating the drive course may obtain search result data derived by searching the first route on SNS. The search result data derived by searching on SNS may include positive/negative responses. The positive/negative responses may include ratings for a location, the ratio of positive/negative sentiment words, and the number of mentions. Words included in the derived search result data may be classified into positive/negative according to a classification of an existing positive/negative sentiment word table.

In step S410, the system for creating the drive course may determine whether the search result data satisfy the predefined reference, and terminate the drive course creation when the search result data does not meet the predefined reference. For example, the system for creating the drive course may check whether the rating for the first route in the search results is greater than or equal to a predefined score, and terminate the course creation when the rating for the first route is less than the predefined score. The predefined score may be a score designated as a score that is more than half of the full score. The predefined score may be a score input by the user and may be modified by the user to input a different score for each driving. The user may selectively register the drive course by setting the predefined score to be high and adjusting a drive course registration condition to be high, and may register many routes as drive courses by setting the predefined score to be low and adjusting the drive course registration condition to be low.

The predefined score may be designated by a server administrator of the system for creating the drive course, and the server administrator of the system for creating the drive course may selectively register the drive course by setting the predefined score to be high and adjusting the drive course registration condition to be high and may register many routes as drive courses by setting the predefined score to be low and adjusting the drive course registration condition to be low.

The system for creating the drive course may check whether the score derived using the positive/negative sentiment words for the first route in the search results is greater than or equal to the predefined score, and may terminate the course creation when the score derived using the positive/negative sentiment words for the first route is less than the predefined score. The system for creating the drive course may check whether the number of mentions for the first route in the search results is greater than or equal to a predefined number of times, and terminate the course creation when the number of mentions for the first route is less than the predefined number of times.

In step S410, the system for creating the drive course may determine whether the search result data satisfy a predefined reference, and obtain a hashtag for the first route in step S420 when the search result data satisfy the predefined reference.

The system for creating the drive course may determine whether the search result data satisfy a predefined reference, and create the drive course when the search result data satisfy the predefined reference. For example, the system for creating the drive course may check whether the rating for the first route in the search results is greater than or equal to a predefined score, and create the course when the rating for the first route is greater than or equal to the predefined score. The system for creating the drive course may check whether the score derived using the positive/negative sentiment words for the first route in the search results is greater than or equal to the predefined score, and may create the course when the score derived using the positive/negative sentiment words for the first route is greater than or equal to the predefined score. The system for creating the drive course may check whether the number of mentions for the first route in the search results is greater than or equal to a predefined number of times, and may create the course when the number of mentions for the first route is greater than or equal to the predefined number of times.

The system for creating the drive course may determine whether the search result data satisfy a predefined reference, and create a drive course having a road where the conduction data satisfy the reference as a starting point and a road where the condition data does not meet the reference as an ending point, when the search result data satisfy the predefined reference.

The system for creating the drive course may determine whether the search result data satisfy a predefined reference, and create a drive course having a road where the conduction data satisfy the reference as a starting point and a road where the condition data satisfy the second reference as an ending point, when the search result data satisfy the predefined reference.

In step S420, the hashtag input for the first route may be, for example, a category of a location. The system for creating the drive course may provide a hashtag input screen on the user device to receive a selection for hashtag from the user.

The first route that has obtained the hashtag for the first route may be registered as a drive course in step S430.

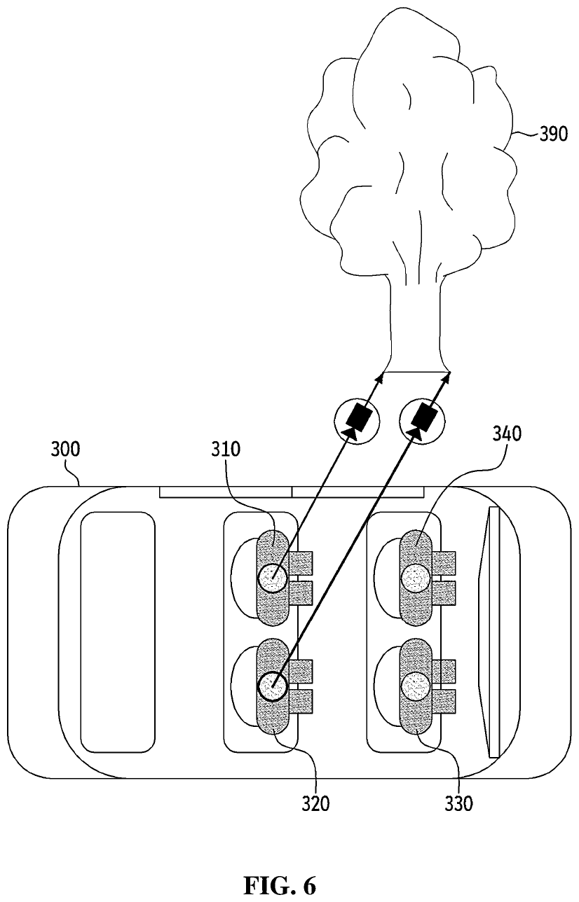

Next, a method for obtaining the drive course creation conditions will be described in detail in FIGS. 6 to 9 below. FIGS. 6 to 9 are illustrative diagrams illustrating a method for obtaining drive course creation data. A screen for obtaining a hashtag will be described later with reference to FIG. 11.

As illustrated in FIG. 6, a mobility apparatus 300 may include a sensor mounted inside thereof, and may obtain passenger gaze data by tracking the gaze of passengers 310, 320, 330, and 340 riding inside the mobility apparatus through the sensor mounted inside thereof.

The sensor mounted inside the mobility apparatus 300 may obtain the case in which the passengers 310, 320, 330, and 340 gaze on the outside for a predefined time or longer or fix their gaze on an object 390 for a predefined time or longer, as the passenger gaze data.

The mobility apparatus 300 that obtains the gaze data of the passengers 310, 320, 330, and 340 riding inside through the sensor mounted inside thereof may transmit the passenger gaze data to the system for creating the drive course.

When the gazes of all passengers 310, 320, 330, and 340 gaze on the outside for a predefined time or longer, the system for creating the drive course may determine that the passenger gaze data satisfy the reference. When only some 310 and 320 of the passengers 310, 320, 330, and 340 gaze on the object 390 for a predefined time or longer as illustrated in FIG. 6, the system for creating the drive course may determine that the passenger gaze data satisfy the reference. Since it is a perfectly normal situation when a motion of a driver 340 is to gaze at a specific object or outside, the motion is not determined as the case in which the passenger gaze data satisfy the reference. Therefore, it is possible to derive an effect of not performing the operation of creating the drive course without going through a separate process of transmitting/receiving and calculating excessive data.

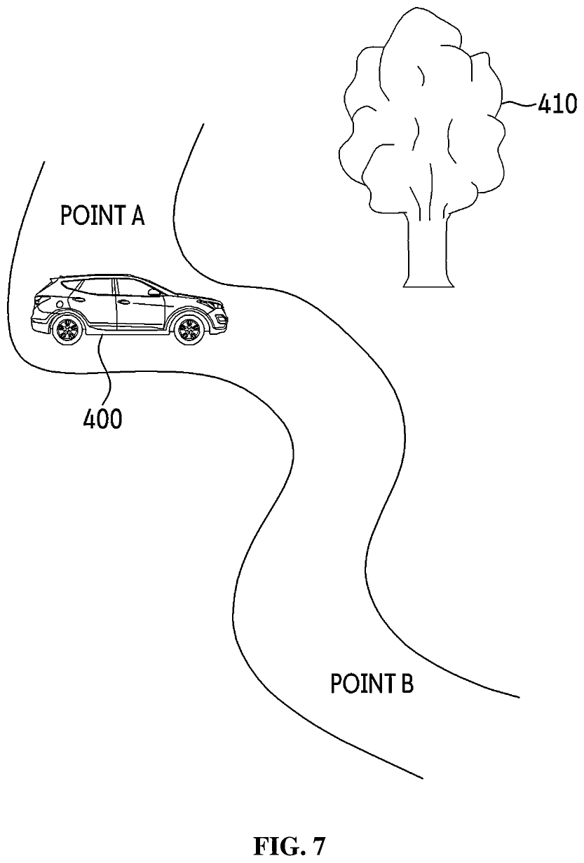

As illustrated in FIG. 7, the system for creating the drive course may create, as a drive course, a road having a point A where the condition data satisfy the reference as a starting point and a point B where the condition data does not meet the reference as an ending point, in a first route through which a mobility apparatus 400 passed. The system for creating the drive course may create, as a drive course, a road having a point A where the condition data satisfy the reference as a starting point and a point B where the condition data does not meet the second reference as an ending point.

For example, the system for creating the drive course may obtain that the location where the decreased speed included in the speed data is decreased by a value of a predefined reference or more is the point A, and obtain that the location where the increased speed included in the speed data satisfy the second reference is the point B. Alternatively, the system for creating the drive course may obtain that the location where the passenger gaze fixation for a predefined time or longer on an object 410 included in the passenger gaze data is the point A, and may obtain that the location that meets the second reference is the point B when the passenger gaze fixation on the object 410 included in the gaze data is released.

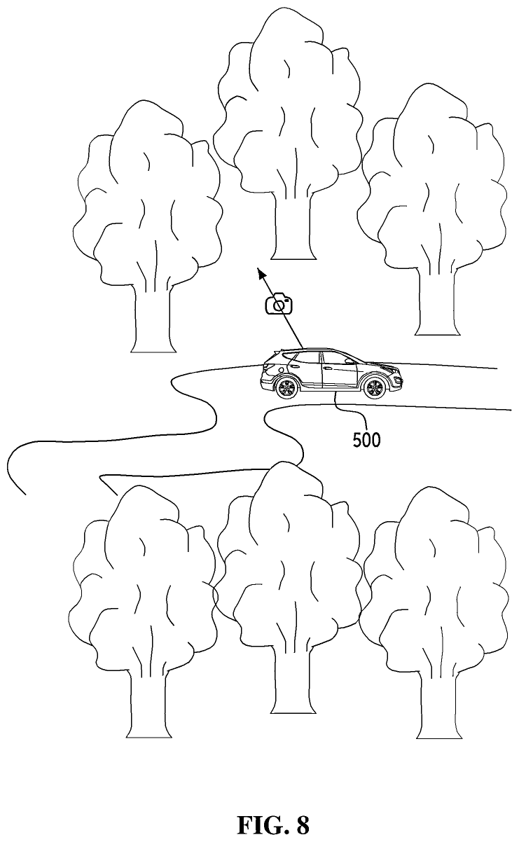

As illustrated in FIG. 8, a mobility apparatus 500 may obtain outside images through a sensor mounted outside thereof. If the outside image included in the obtained outdoor scenery data is included in a predefined landscape category, the system for creating the drive course may determine that the outdoor scenery data satisfy the reference. For example, when it is determined that the obtained mobility outside image is included in the forest, which is a predefined landscape category, the location where the image was obtained may be used as a feature point indicating that it is the location included in the forest, which is one of the predefined landscape categories.

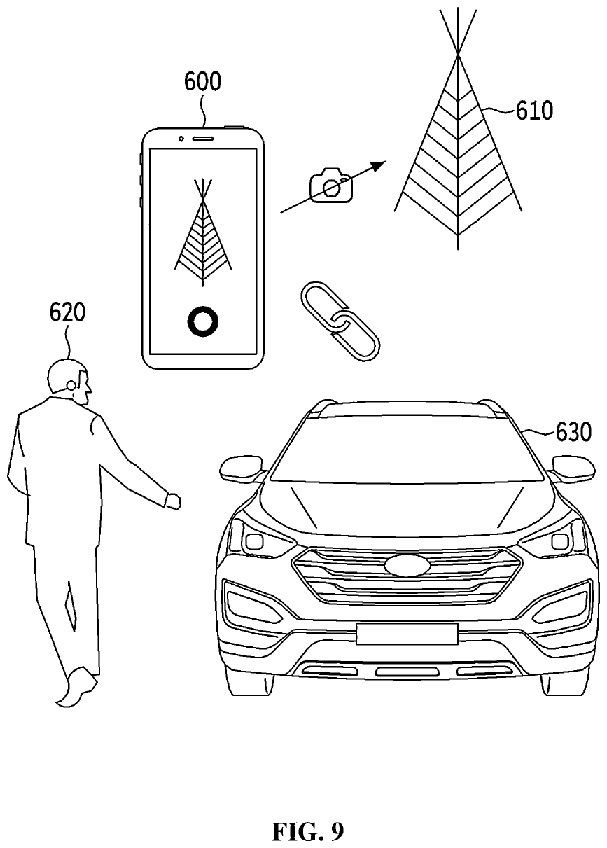

As illustrated in FIG. 9, a mobility apparatus 630 may be linked to a passenger device 600 of a passenger 620 via wireless communication including NFC, Bluetooth, Zigbee, or a beacon. In the linked passenger device, a manipulation by the passenger 620 for photographing an object 610 may occur. The system for creating the drive course may obtain a manipulation signal of the passenger 620 as passenger device data.

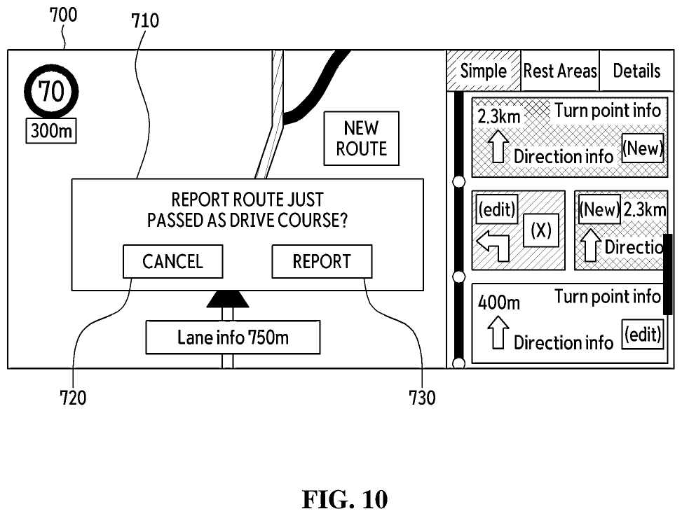

Next, a method for obtaining a drive course creation report will be described in detail in FIGS. 10 and 11 below. FIGS. 10 and 11 are illustrative diagrams illustrating navigation screens that provide a drive course creation service.

As illustrated in FIG. 10, the system for creating the drive course may obtain a drive course report signal by providing a drive course report screen to a user device or a passenger device and receiving a report selection input from the user. Alternatively, the system for creating the drive course may terminate the process of creating the drive course by providing the drive course report screen to the user device or the passenger device and receiving a report non-selection input from the user. For example, a pop-up message 710 may be generated on a navigation screen 700 to receive a selection for a report 730 and obtain a drive course report signal. Alternatively, the pop-up message 710 may be generated on the navigation screen 700 to receive a selection for a cancellation 720 and terminate the process of creating the course.

As illustrated in FIG. 11, the system for creating the drive course may provide a hashtag input screen on the user device or passenger device to receive a hashtag selection for the route from the user.

For example, a pop-up message 810 may be generated on a navigation screen 800 to receive a selection for one of the hash recommendation categories 820 and 830 or a direct input 840 to generate a course including a hashtag for the route.

So far, the method for creating the drive course according to some exemplary embodiments of the present disclosure has been described with reference to FIGS. 1 to 11. The methods according to the exemplary embodiments of the present disclosure described so far may be performed by executing a computer program implemented as a computer-readable code. The computer program may be transmitted from a first computing device to a second computing device via a network such as the Internet and installed on the second computing device, thereby allowing it to be used on the second computing device. In addition, although the operations are illustrated in a specific order in the drawings, it should not be understood that the operations need to be performed in the specific order illustrated or in any sequential order, or that all illustrated operations need to be performed to achieve the desired result. In particular situations, multitasking and parallel processing may be advantageous.

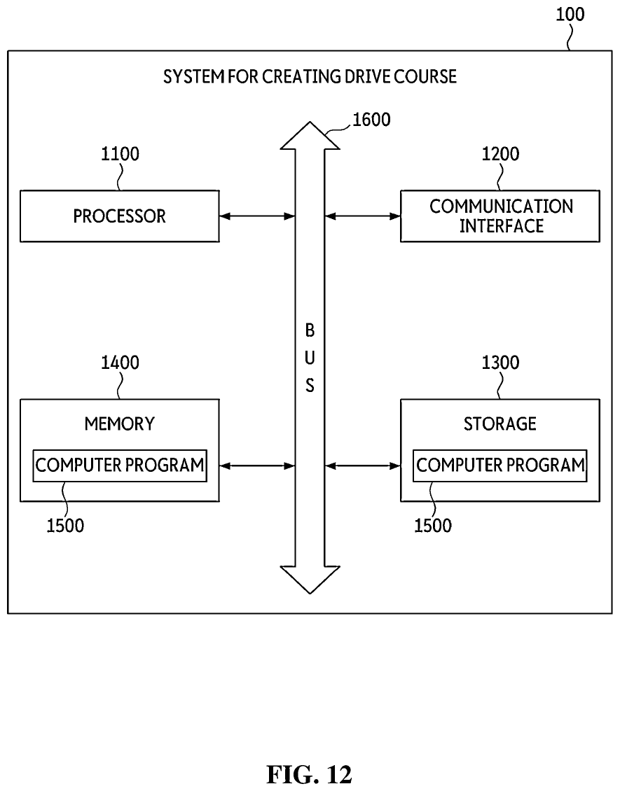

Hereinafter, a hardware configuration of the system for creating the drive course will be described with reference to FIG. 12. FIG. 12 is a hardware configuration diagram of a system 100 for creating a drive course according to some exemplary embodiments of the present disclosure. The system 100 for creating the drive course of FIG. 12 may refer to, for example, the system 100 for creating the drive course described with reference to FIG. 1. The system 100 for creating the drive course may include one or more processors 1100, a system bus 1600, a communication interface 1200, a memory 1400 for loading a computer program 1500 executed by the processor 1100, and a storage 1300 for storing the computer program 1500.

Here, the communication interface 1200 may also receive driving information of the mobility apparatus 300 in real time by being connected to an electronic control unit (ECU) of the mobility apparatus 300 described with reference to FIG. 2 via a controller area network (CAN).

The processor 1100 controls the overall operation of each component of the system 100 for creating the drive course. The processor 1100 may perform a calculation on at least one application or program for executing the methods/operations according to various exemplary embodiments of the present disclosure. The memory 1400 stores various data, commands, and/or information. The memory 1400 may load one or more programs 1500 from the storage 1300 to execute the methods/operations according to various exemplary embodiments of the present disclosure. The bus 1600 provides a communication function between the components of the system 100 for creating the drive course. The communication interface 1200 supports Internet communication of the system 100 for creating the drive course. The storage 1300 may non-temporarily store one or more computer programs 1500. The computer program 1500 may include one or more instructions in which the methods/operations according to various exemplary embodiments of the present disclosure are implemented. When the computer program 1500 is loaded into the memory 1400, the processor 1100 may perform the methods/operations according to various exemplary embodiments of the present disclosure by executing the one or more instructions.

In some exemplary embodiments, the system 100 for creating the drive course described with reference to FIG. 12 may be configured using one or more physical servers included in a server farm based on a cloud technology such as a virtual machine. In this case, at least some of the processor 1100, the memory 1400, and the storage 1300 among the components illustrated in FIG. 12 may be virtual hardware, and the communication interface 1200 may also be configured as a virtualized networking element such as a virtual switch.

The computer program 1500 may include instructions of performing an operation of obtaining a first route driven along which a mobility apparatus of the system 100 for creating the drive course has driven, an operation of obtaining passenger gaze data while driving along the first route, an operation of analyzing the passenger gaze data, an operation of determining whether at least a portion of the first route is suitable as a drive course by using the analysis results of the passenger gaze data, and an operation of transmitting data for at least a portion of the first route determined to be suitable as the drive course to a navigation service server.

Embodiments of the present disclosure have been described above with reference to FIGS. 1 through 12, but it should be noted that the effects of the present disclosure are not limited to those described above, and other effects of the present disclosure should be apparent from the following description.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those having ordinary skill in the art should appreciate that many variations and modifications can be made to the embodiments without substantially departing from the principles of the present disclosure. Therefore, the disclosed embodiments of the present disclosure are used in a generic and descriptive sense only and not for purposes of limitation.

What is claimed is:

1. A method for creating a drive course, performed by a mobility apparatus, the method comprising:
obtaining a first route along which the mobility apparatus has driven;
obtaining passenger gaze data while driving along the first route;
analyzing the passenger gaze data;
determining whether at least a portion of the first route is suitable as a drive course by using an analysis results of the passenger gaze data; and
transmitting data for the at least the portion of the first route determined to be suitable as the drive course to a navigation service server.

2. The method of claim 1, wherein the obtaining the passenger gaze data includes:
obtaining condition data of the first route; and
obtaining the passenger gaze data when the condition data of the first route meets a predefined reference, and
wherein the condition data includes a speed data, an outdoor scenery data, a window data, a sound data, or a passenger device data.

3. The method of claim 2, wherein the speed data of the mobility apparatus, which is the condition data that meets the predefined reference, indicates that the mobility apparatus is to be decelerated while entering the first route.

4. The method of claim 2, wherein the outdoor scenery data, which is the condition data that meets the predefined reference, indicates that the outdoor scenery data is to be determined as a predefined landscape.

5. The method of claim 2, wherein the window data, which is the condition data that meets the predefined reference, indicates that the mobility apparatus is to open a window while entering the first route.

6. The method of claim 2, wherein the sound data, which is the condition data that meets the predefined reference, indicates that decibels of a predefined reference or more is to occur inside the mobility apparatus while the mobility apparatus enters the first route.

7. The method of claim 2, wherein the passenger device data, which is the condition data that meets the predefined reference, indicates that photographing is to be performed on a passenger device linked to the mobility apparatus.

8. The method of claim 1, wherein the determining whether the at least the portion of the first route is suitable as the drive course by using the analysis results of the passenger gaze data includes:
obtaining that a gaze of a passenger on the first route has gazed outside for a predefined time or longer;
obtaining a condition data of the first route; and
determining whether the at least the portion of the first route is suitable as the drive course when the condition data of the first route meets a predefined reference, and
wherein the condition data includes a speed data, an outdoor scenery data, a window data, a sound data, or a passenger device data.

9. The method of claim 1, wherein the determining whether the at least the portion of the first route is suitable as the drive course includes receiving a drive course report signal from a user.

10. The method of claim 1, wherein the transmitting data for the at least the portion of the first route determined to be suitable as the drive course to the navigation service server further includes:
obtaining a search result data by searching the first route on a social network service (SNS); and
registering the first route as the drive course when the search result data satisfy a predefined reference.

11. The method of claim 10, wherein the registering the first route as the drive course when the search result data satisfy the predefined reference includes registering the first route as the drive course when the search result data satisfy a positive evaluation reference.

12. The method of claim 10, wherein the registering the first route as the drive course when the search result data satisfy the predefined reference includes registering the first route as the drive course when the search result data satisfy a mention reference.

13. The method of claim 10, wherein the registering the first route as the drive course when the search result data satisfy the predefined reference includes:
receiving a hashtag for the first route; and
mapping the hashtag to the first route.

14. A server for creating a drive course, the server comprising:
a communication interface;
a memory into which a computer program is loaded; and
at least one processor, when the computer program is executed, causes the computer program to perform a method comprising:
obtaining a first route along which a mobility apparatus has driven;
requesting passenger gaze data to the mobility apparatus while the mobility apparatus drives along the first route;
obtaining and analyzing the passenger gaze data;
determining whether at least a portion of the first route is suitable as a drive course by using analysis results of the passenger gaze data; and
registering data for the at least the portion of the first route determined to be suitable as the drive course.

15. A system for creating a drive course, the system comprising:
at least one processor; and
a memory configured to store a set of instructions,
wherein the at least one processor, when the set of instructions are executed, causes the set of instructions to perform a method comprising:
obtaining a first route along which a mobility apparatus has driven;
obtaining passenger gaze data while driving along the first route;
analyzing the passenger gaze data;
determining whether at least a portion of the first route is suitable as a drive course by using analysis results of the passenger gaze data; and
transmitting data for the at least the portion of the first route determined to be suitable as the drive course to a navigation service server.

16. The system of claim 15, wherein the obtaining the passenger gaze data includes:
obtaining condition data of the first route; and
obtaining the passenger gaze data when the condition data of the first route meets a predefined reference, and
wherein the condition data includes a speed data, an outdoor scenery data, a window data, a sound data, or a passenger device data.

17. The system of claim 16, wherein the window data, which is the condition data that meets the predefined reference, indicates that the mobility apparatus is to open a window while entering the first route.

18. The system of claim 16, wherein the sound data, which is the condition data that meets the predefined reference, indicates that decibels of a predefined reference or more is to occur inside the mobility apparatus while the mobility apparatus enters the first route.

19. The system of claim 15, wherein the determining whether the at least the portion of the first route is suitable as the drive course by using the analysis results of the passenger gaze data includes:
obtaining that a gaze of a passenger on the first route has gazed outside for a predefined time or longer;
obtaining a condition data of the first route; and
determining whether the at least the portion of the first route is suitable as the drive course when the condition data of the first route meets a predefined reference, and
wherein the condition data includes a speed data, an outdoor scenery data, a window data, a sound data, or a passenger device data.

20. The system of claim 15, wherein the transmitting the data for the at least the portion of the first route determined to be suitable as the drive course to the navigation service server further includes:
obtaining a search result data by searching the first route on an SNS; and
registering the first route as the drive course when the search result data satisfy a predefined reference.
